(19) United States
(12) Patent Application Publication
(10) Pub. No.: US 2026/0227771 A1
(43) Pub. Date: Aug. 6, 2026

(54) MACHINE PARAMETER OPTIMISATION

(71) Applicant: Cargill, incorporated, Wayzata, MN (US)

(72) Inventors: Amina ALAOUI, Grimbergen (BE); Loic Jean-François AUTRET, Pruillé (FR); Jeremy Anthony Philippe GRUEL, Amstelveen (NL)

(73) Assignee: Cargill, incorporated, Wayzata, MN (US)

(21) Appl. No.: 19/148,424

(22) PCT Filed: Jan. 26, 2024
(86) PCT No.: PCT/US2024/013079

§ 371 Date: Jul. 16, 2025

(30) Foreign Application Priority Data
Jan. 27, 2023 (EP) 23153808.3

(51) Int. Cl. G05B 19/418

(52) U.S. Cl. CPC G05B 19/41885; G05B 2219/32015

(57) ABSTRACT

A method for optimising a plurity of production parameters of a production machine having a productive output, comprising, at a computer apparatus having access to a computer-readable storage medium and coupled to the production machine: in a first step: modifying at least one first parameter of the plurality of parameter production s, determining at least one corresponding impact on the production output due to said modifying, and storing the determined at least one corresponding impact on the production output on the computer-readable storage medium; and in a second step: selecting a second parameter from among the at least one first parameter, based on the at least one stored corresponding impact on the production output for the at least one first parameter and based on a desired impact on the production machine; and modifying the selected second parameter in order to optimise the production output towards the desired impact.

### CROSS-REFERENCE TO RELATED APPLICATIONS

This application claims the benefit of European Patent Application Serial No. 23153808.3 filed 27 Jan. 2023, entitled “MACHINE PARAMETER OPTIMISATION”, which application is hereby incorporated by reference herein in its entirety.

### FIELD OF THE INVENTION

The present disclosure generally relates to machine parameter optimisation. Specific aspects relate to a method for optimising at least one parameter of a production machine, a computer program for performing such a method, a computer program product storing such a computer program, a computer apparatus comprising such a computer program product, and a production machine operatively coupled to such a computer apparatus.

### BACKGROUND

Production machines, e.g. stretch blow machines, but also other types of production machines, typically have many parameters that can be set to a setting in order to control operation of the production machine. In this way, the machine can produce a product output, but it may also bring about other types of output, which may be interpreted as output signals of the production machine, e.g. noise, heat, electromagnetic radiation, station alignment, machine durability or other maintenance-related signals, consumption of energy (electricity and/or fuel) and/or of other resources such as water and raw materials.

Typically, human operators set these parameters to some setting in order to achieve a desired output. However, this depends on the know-how of experienced operators. Therefore, there may be a problem if less experienced operators are to operate the production machines, who may be less familiar with the relation between settings of the parameters on the one hand and desired output on the other hand. Moreover, in many production facilities, production machines operate for prolonged times, e.g. crossing shift times of operators. This may lead to a problem wherein a new operator or group of operators becomes responsible in a new shift but is less aware of the situation of a production machine during a previous shift, and thus may fail to adequately operate the machine.

Aldeida Aleti et al: “Choosing the appropriate forecasting model for predictive parameter control”, Evolutionary Computation, MIT Press, Cambridge, MA, US, vol. 22, no. 2, 1 Jun. 2014, pages 319-349, discloses prediction methods for the projection of future parameter performance based on previous data, looking specifically at parameters of evolutionary algorithms (EAs).

EP 3 989 024 A1 discloses a method of adapting control parameter values in order to reduce vibration to extend Remaining Useful Life, RUL, of a rolling-element bearing of an electrical machine. The element that is being compared over iterations of the method is the RUL, which is an individual resultant property of the electrical machine, but is not a production parameter.

### SUMMARY OF THE INVENTION

Recently, more and more production machines are being equipped with sensors and are adapted to set their parameters via a computer.

The inventors have identified an opportunity to better formalise and systematise the way that operators operate such production machines, using the sensors and the new ability of computer-set parameters.

It is therefore an aim of aspects of the present disclosure to address this opportunity. It is a further aim of aspects of the present disclosure to overcome any of the problems described above. It is another aim of aspects of the present disclosure to improve operation of production machines in general. If is moreover another aim of aspects of the present invention to do so online, i.e. during operation of the production machine.

In a first aspect, there is provided a method for optimising a plurality of production parameters of a production machine having a production output, comprising, at a computer apparatus having access to a computer-readable storage medium and coupled to the production machine: in a first step: modifying at least one first parameter of the plurality of production parameters, determining at least one corresponding impact on the production output due to said modifying, and storing the determined at least one corresponding impact on the production output on the computer-readable storage medium; and in a second step: selecting a second parameter from among the at least one first parameter, based on the at least one corresponding stored impact on the production output for the at least one first parameter and based on a desired impact on the production machine; and modifying the selected second parameter in order to optimise the production output towards the desired impact.

In other words, the method may include a first step functioning as an exploration phase and a second step functioning as an exploitation phase. In the exploration phase, preferably sequentially, the production output may be measured, the parameter may be modified, the production may be allowed to reach a new stable state and the production may be measured again. The difference between the two measurements may be assessed, as an impact corresponding with the modification of the parameter, and may be recorded for further use. In the exploitation phase, based on a preferably curated history of recorded parameter modifications and their corresponding impacts, the parameter with the highest predicted odds of achieving the desired impact, i.e. the best odds of changing the production towards a user-defined production output, may be selected and modified.

By determining at least one corresponding impact on the production output due to modifying the at least one first parameter, the method is able to learn effectively about the impact of changing a parameter, and by selecting and modifying the second parameter from among the at least one first parameter, based on the at least one corresponding impact for the at least one first parameter and based on a desired impact on the production machine, the method allows for a robust optimisation, whilst still maintaining safe and predictable operation.

It is currently believed that the robustness in the optimisation may stem at least in part from insulating the parameter modifications and outcomes from anything else happening (such as another parameter modification, or an unstable process). This may result in clean, independent data for each modifiable parameter, that allows to look back at what is happening and allows to (in future) understand the machine better. Therefore, it is not necessary to understand the complete machine, but it may advantageously suffice to understand what is happening in the vicinity of the current process, i.e. the current operation of the production machine with the currently set parameters. The models fitted for each modifiable parameter may in that sense be seen as akin to finding the partial derivatives of the process: they give a sense of which parameter is the one that will have the most impact.

Preferably, the effect of time may be taken into account when selecting the second parameter, in order to optimize a predicted magnitude of production displacement towards objective per unit of time.

Advantageously, this increases the overall efficiency of the method, because parameters that are faster or slower to be modified and/or faster or slower to result in effect relatively to other parameters may be treated differently.

In a further-developed aspect, the step of modifying the at least one first parameter in the first step comprises:
calculating at least one partial derivative of the at least one stored corresponding impact on the production output for the at least one first parameter;
   wherein the second parameter is selected from among the at least one first parameter, based on the calculated at least one partial derivative.

In a further-developed aspect, the method comprises:
stabilizing the production machine by enforcing a stabilization time representing a time necessary for the corresponding impact to take effect on the production output due to said modifying of said respective first parameter, after said modifying of the at least one first parameter and/or the selected second parameter.

Advantageously, by allowing the production machine to stabilize, amongst others, safety may be improved and also the certainty of the overall optimisation may be improved, because impacts from different modifications may be separated more clearly.

In a particular aspect, the second step is repeated until a desired production output is achieved. In a preferred development of this aspect, the first step and the second step are repeated in alternation until a desired production output is achieved. Advantageously, this allows to adhere closely to the user's desire.

In a further-developed aspect, the method comprises, when any parameter among the plurality of production parameters is modified by a modification in the first step and/or in the second step: storing the modification of said parameter; evaluating a corresponding change in the production output due to the modification, optionally after waiting for a settling time duration; and storing the corresponding change. Advantageously, this provides for an improved insight into historical modifications, and moreover this may improve records for maintenance and/or auditing.

In other words, whenever a parameter is modified, be it within the exploration or exploitation phase, the following steps may take place:
1) measure production over a measure time;
2) parameter modification;
3) wait during a stabilisation time;
4) measure production again over the measure time; and
5) compare and record the measurements made in steps 1) and 4).

Changing any parameter in any of the two phases therefore takes an incompressible amount of time, namely measure time * 2+stabilisation time. (This example assumes that the measure time is identical before and after the parameter modification, which is usually the case. However, it is conceivable that a different measure time may be used after than before the modification, in which case the skilled person will of course understand that this mathematical formula is changed accordingly.)

In the exploration phase, the parameter may be selected for which the oldest last measurement is available (and the best direction may be chosen according to the data available).

In the exploitation phase, both the best parameter and the best direction may be chosen, based on predictions for all parameters.

In this sense, both the exploration and the exploitation may help to feed the data that is used for making predictions.

In a further-developed aspect, the corresponding change in the production output due to the modification is evaluated using a plurality of sensors, preferably arranged in different regions of the production machine, and the step of selecting the second parameter from among the at least one first parameter based on the at least one stored corresponding impact on the production output for the at least one first parameter preferably comprises taking into account multiple objective functions corresponding with the plurality of sensors. Advantageously, by using multiple sensors it is possible to balance the optimisation method in a way that is inherently not possible if just a single sensor would be used, because using just a single sensor by necessity leads to blind spots that cannot be compensated, whereas using multiple sensors allows the skilled person to reduce or even eliminate such blind spots. Additionally, by taking into account multiple objective functions that correspond with those multiple sensors, the method can be made more finely focused, because each sensor's region of operation can be optimised separately. In this case, it is preferred to provide an overall objective function to make a weighted combination of those multiple objective functions, to ensure fluent and predictable operation.

In a further-developed aspect, the method comprises, when any parameter among the plurality of production parameters is modified by a modification in the first step and/or in the second step, determining an impact on the production output of modifying said parameter, by: retrieving at least one modification and at least one change in the production output corresponding with the at least one retrieved modification, for said parameter; and fitting a regression model for the at least one retrieved modification and the at least one retrieved change for said parameter, in order to determine the impact on the production output of modifying said parameter.

In a further-developed aspect, the step of fitting the regression model comprises attributing a relatively lower weight to relatively older modifications and relatively older corresponding changes in the production output compared to relatively newer modifications and relatively newer corresponding changes in the production output. Advantageously, this ensures that relatively newer data is given a relatively greater weight, thus helping to ensure that more relevant data carry more weight in the actual regression, as the state of the production machine may have changed more considerably compared to relatively older modifications than compared to relatively newer modifications, since the production machine may have had less time or less modifications since the respective modification in question.

In a further-developed aspect, the step of fitting the regression model comprises taking into account a current value of said parameter and a current value of the production output. This takes mathematical advantage of the insight that no modification to the parameter likely leads to no change in the production output.

In a further-developed aspect, the regression model is a linear function model. Approximating the partial derivatives of the otherwise unfathomable production machine, the model provides actionable information in the vicinity of the current production settings.

In a further-developed aspect, each parameter of the plurality of production parameters of the production machine is associated with a predetermined step size; and the step of modifying the at least one first parameter in the first step comprises determining the modification for said parameter as either a decrease of at least one step size or an increase of at least one step size for said parameter, optionally subject to at least one pre-determined allowability criterion for modification of said parameter. Advantageously, this ensures that relevant yet feasible modifications are considered for the exploration phase.

An example of such a pre-determined allowability criterion is that a best predicted modification (in terms of magnitude/time) may e.g. not be picked if the modification would take a parameter outside of an allowed range of values for that parameter (if the parameter is still/already within its allowed range), or if the modification would take the parameter further away from its allowed range (if the parameter is already outside its allowed range. In this manner, the method ensures rational, predictable behaviour.

In that case, it is preferred to proceed to the next best parameter to modify, and to keep proceeding until a parameter modification is found that is allowed according to the pre-determined allowability criterion.

In a further-developed aspect, the method further comprises: obtaining a definition of a desired production output for the production machine, wherein the definition has been obtained via a user interface; evaluating a current production output of the production machine; and determining a difference between the desired production output and the current production output as the desired impact on the production output. Advantageously, this allows a close adherence to the user's desires.

In a further-developed aspect, the method further comprises: determining, among the plurality of production parameters, at least one parameter lacking a respective determined impact; and modifying the at least one parameter that has been determined to be lacking a respective determined impact, and determining at least one corresponding impact on the production output due to said modifying. Additionally or alternatively, the method further comprises: determining, among the at least one first parameter, at least one parameter having a most stale respective determined impact; and modifying the at least one parameter that has been determined to be having a most stale respective determined impact, and determining at least one corresponding impact on the production output due to said modifying. Advantageously, this allows to ensure that plenty of parameters are available for the optimisation, and that sufficiently recent insights are available.

In a further-developed aspect, the step of selecting the second parameter further comprises: sorting the at least one corresponding impact for the at least one first parameter according to a sorting criterion based on a respective contribution of the corresponding impact to the desired impact on the production output; and choosing as the second parameter the parameter whose corresponding impact was sorted to have the highest contribution to the desired impact. Advantageously, this ensures an efficient path to optimise the parameters.

In a further-developed aspect, the step of sorting the at least one respective impact for the at least one first parameter optionally takes into account respective parameter costs for respective parameters of the plurality of production parameters; and/or optionally takes into account respective modification costs for respective modifications to parameters of the plurality of production parameters. Advantageously, this ensures that infeasible or undesirable modifications may be excluded or penalised.

In a second aspect, there is provided a computer program comprising instructions configured for, when executed on a computer processor, performing the above-described method.

In a third aspect, there is provided a computer readable medium storing the above-described computer program.

In a fourth aspect, there is provided a computer apparatus storing the above-described computer program and configured for performing the above-described method.

In a fifth aspect, there is provided a production machine operatively coupled to the above-described computer apparatus.

The skilled person will understand that advantages and considerations that apply for the above-described method apply analogously for the computer program, the computer-readable medium, the computer apparatus and the production machine, mutatis mutandis.

It will be appreciated that the above-described aspects as well as the below-described aspects and examples are intended to illustrate the principles of the present disclosure, and that particular features from particular aspects may be combined to form other aspects in any manner that the skilled person will understand to be technically sound.

### BRIEF DESCRIPTION OF THE DRAWINGS

Aspects of the present disclosure will be more fully understood with the help of the examples described below and with the help of the appended drawings, in which:

FIGS. 1A and 1B schematically illustrates flowcharts of an aspect of a method according to the present disclosure;

FIG. 2 schematically illustrates a production machine having multiple parameters for optimising using an aspect of a method according to the present disclosure;

FIG. 3 schematically illustrates four graph panes of production variation in relation to variations of an arbitrary parameter p₀, wherein the four panes represent the observed production variation (y-axis) according to sensors s₀, s₁, s₂ and s₃ upon variation of parameter p₀ (x-axis); and

FIG. 4 schematically illustrates four graph panes of an output parameter, in this example material thickness, varying over time, due to modifications being made by operation of an aspect of a method according to the present disclosure, e.g. method 100.

### DETAILED DESCRIPTION

In the following description, the term production machine may refer to any machine involved in a production process wherein the machine produces a product forming part of its output, and wherein the machine may further effect other outputs, such as signal outputs, e.g. the heat or noise that the machine produces (typically as by-products), or e.g. the resources such as power, materials or production time that the machine consumes in order to produce the product. It is considered that aspects according to the present disclosure may be applicable to any machine having such outputs. In a practical example, it may be preferred if the latency in the production process between modifying a parameter and obtaining an impact on production is relatively short.

### Loss Function

In some aspects, determining which parameter offers the best odds of improving the production may comprise minimising a loss function. The loss function may e.g. be based on a user input describing an ideal production output and may e.g. translate user-input commands such as “more material is needed at a given location along the body of the product” into mathematical or engineering commands.

In this way, the loss function may be better explainable, i.e. it may be designed in such a way that its operation and its context can better be made clear to humans, also thanks to the use of readily understandable graphical displays.

In a practical implementation, the method may use an objective function, preferably a loss function representing the desired production output minus the actual current production output per unit of time, preferably clipped to a non-negative value. Thus, the function preferably has a positive value when there is not enough material and the higher the value the further away from the ideal. The clipping of a negative value translates into: “there is enough material here, so it is not necessary to further modify”.

In a further-developed implementation, the method may use multiple objective functions, for example corresponding with multiple sensors, in order to improve fine-grained control of specific regions or elements of the optimisation process, and for example also to improve energy consumption of the production machine.

### Optimisation

The problem of optimising a production machine is a physical problem: evaluating the value of the loss function for a given set of parameters entails that bottles have to be made and measured. By utilising an optimisation method with iterative parameter modifications bounded by their previous state, destructive evaluations may be avoided, in which produced bottles would end up having more than one hole, which may be undesirable.

In an example of an aspect of a method according to the present disclosure, the optimisation may start from a set of parameters resulting in bottles, and the loss function may be designed based on improvements to make to these bottles.

For each parameter a set of bounds may be defined: a minimum value, a maximum value, a step size by which the method is allowed to modify the parameter, a measuring time duration, and a process stabilisation duration.

The example of the aspect of the method may proceed as follows for the optimisation phase:

1. For each parameter, select the n most recent recorded parameter modifications and associated production variation. It will be understood that n may be a natural number, at least 1, and may preferably be not too small (preferably greater than 5), in order to balance freshness vs. data availability (in the sense that the more data there is available, the better models are fitted, but then the average data point becomes more stale and predictions may become less relevant). Putting more emphasis on recent data (either by using less old data overall and/or by attributing a relatively stronger weight to recent data), will make the method change production output faster, but the choices may become less accurate.
2. For each parameter, fit a linear model predicting production variation from parameter modifications. Of course, other types of models than linear models could also be used-a linear model with a high bias may be effective with less data than models that use lower bias and higher variance. In that case a linear model may improve trustworthiness.
3. For each parameter, and each of an increase or a decrease of the parameter value by its step size, compute the predicted loss function value resulting from the parameter modification.
4. Rank predictions according to the value of the loss function., or more precisely, ranking parameter modifications according to an expected magnitude of production displacement towards the objective (encoded via the loss function), per unit of time.
5. Starting with the lowest cost function predictions, sequentially assess whether the corresponding parameters modification can be implemented (i.e. the parameter value after modification by step size still falls within its minimal and maximal allowed values). The first allowed parameter modification is selected.
6. Implement and record the selected parameter modification.
7. If the loss function increases between the two measurements of step 6, implement and record the reverse of the selected modification (thereby restoring the situation to before the modification made in step 6).

An additional aspect of the method, the exploration phase, ensures the algorithm keeps an updated memory. In this phase, the parameter with the oldest latest recorded modification is preferably selected (although other parameters may in principle be chosen instead), as this parameter is the most ‘stale’ and thus probably the least informative about the current condition of the production machine.

If the parameter has no recorded memory, it may be considered to implement and record an allowed arbitrary increase or decrease of the parameter. Furthermore, if the modification leads to an increase of the loss function, it is preferred to reverse the modification (thus restoring the situation to before the modification) and to record this reversal.

Else, the optimisation algorithm may be followed for the special case of where the only modifications assessed are either an increase or a decrease of the selected parameter by its step size.

The method is designed to alternate the optimisation/exploitation and exploration phases, with typically more frequent optimisation/exploitation phases than exploration ones, for example a ratio of five optimisation/exploitation phases to one exploration phase. Of course, other ratios may also be considered, for example, one exploitation phase to one exploration phase, or a 100 exploitation phases to one exploration phase. It is in principle even possible to have more exploration phases than exploitation phases, for example two exploration phases to one exploitation phase, although this would be equivalent to considering the two exploration phases as one single, larger exploration phase. Also, this ratio, as well as the duration of the individual phases, do not need to be fixed, but may vary, depending on the circumstances.

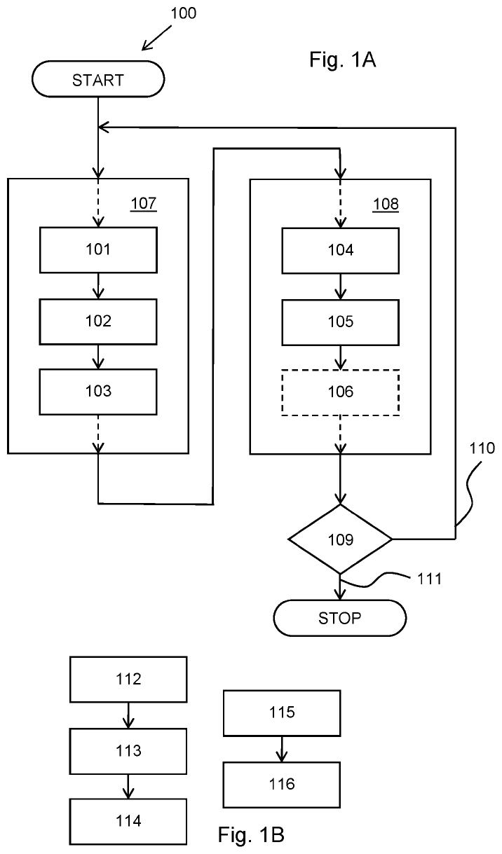

FIG. 1A schematically illustrates a flowchart of an aspect of a method 100 according to the present disclosure. The method 100 is for optimising a plurality of production parameters of a production machine having a production output. The method 100 comprises at least the illustrated steps 101-105, bundled in at least two larger steps, namely a first step 107 and a second step 108. The method 100 can be performed at (i.e. by a processor of) a computer apparatus having access to a computer-readable storage medium and coupled to the production machine.

Step 107 represents the first step. Step 101 comprises modifying at least one first parameter of the plurality of production parameters. Step 102 comprises determining at least one corresponding impact on the production output due to said modifying. Step 103 comprises storing the determined at least one corresponding impact on the production output on the computer-readable storage medium.

Step 108 represents the second step. Step 104 comprises selecting a second parameter from among the at least one first parameter, based on the at least one stored corresponding impact on the production output for the at least one first parameter and based on a desired impact on the production output. Step 105 comprises modifying the selected second parameter in order to optimise the production output towards the desired impact.

Step 106 is optional and simply represents the production machine actually producing output.

In step 109, the method may comprise determining whether or not a halting criterion has been reached (for example: does production output match requirements?). If the halting criterion has not yet been reached, the method may return 110 to the first step 107. If the halting criterion has been reached, the method may halt 111. In this way, the second step may be repeated until a desired production output is achieved. It is preferred (and illustrated in FIG. 1) that the first step and the second step are repeated in alternation until a desired production output is achieved. Of course, the skilled person will understand that in or immediately after transition 110, the method 100 may simply skip the first step 107 and may commence with the second step 108 without performing the first step 107, if it is desired to repeat the second step multiple times without executing the first step.

Moreover if the method has halted at step 111, in further developed aspects, the method may comprise once or periodically rechecking to determine if there is any drift in production output away from the desired production output (e.g. due to ambient temperature of the production machine's environment). In that case, the method may simply recommence.

FIG. 1B schematically illustrates a flowchart of a detail of an aspect of a method according to the present disclosure. The detail shown in FIG. 1B may for example be added to method 100 of FIG. 1A, and comprises, when any parameter among the plurality of production parameters is modified by a modification in the first step and/or in the second step, e.g. in steps 101 and/or 105:
storing 112 the modification of said parameter;
evaluating 113 a corresponding change in the production output due to the modification, optionally after waiting for a settling time duration; and
storing 114 the corresponding change.

Likewise, when any parameter among the plurality of production parameters is modified by a modification in the first step and/or in the second step, e.g. in steps 101 and/or 105, determining an impact on the production output of modifying said parameter, by:
retrieving 115 at least one modification and at least one change in the production output corresponding with the at least one retrieved modification, for said parameter; and
fitting 116 a regression model for the at least one retrieved modification and the at least one retrieved change for said parameter, in order to determine the impact on the production output of modifying said parameter.

In some aspects according to the present disclosure, it may be advantageous to disable or at least design around a built-in control function of the production machine, if the production machine has such a built-in control function to control operation of the production machine, for example to control power delivery to heating elements in order to achieve a set temperature value. The reason for this is that such a built-in control function may otherwise be hindered by and/or may otherwise hinder the operation of those aspects according to the present disclosure. The details of how to implement this disabling or this designing around are left to the skilled person.

In practical aspects of the method according to the present disclosure, the method may for example be implemented as a computer program comprising instructions in a programming language, configured for, when executed on a computer processor, performing the method. The programming language may be any suitable programming language, and may be a high-level programming language such as C, C++, Java, C#, Python or Clojure, or a combination thereof, or may be a machine programming language.

It will be clear to the skilled person that a computer apparatus may be provided comprising a computer program product comprising a computer readable medium storing such a computer program, and that such a computer apparatus may be operatively coupled to the production machine, e.g. by means of a channel for communicating data and control signals. It is considered implicit that the computer apparatus comprises a computer processor.

Preferably, the method is halted when a predefined halting criterium is reached, by repeating the steps until a desired production output is achieved, e.g. when an estimated impact of a next modification will not significantly benefit the desired production output, or e.g. when the value of an overall loss function is below a predefined threshold. Preferably, the method may be started or restarted when a predefined starting criterium is reached, e.g. when the value of the above-described loss function is above the predefined threshold.

In a further-developed aspect, the method comprises a method for determining an optimal parameter selection. All possible parameter modifications are predicted using a linear model fitted with the most recent recorded parameter modification recorded, and further ranked following their predicted potential to bring the production towards a user defined optimum.

In this way the method can rapidly learn the current interplay between machine parameters and production output to offer a relevant suggestion.

In a further developed aspect, the method comprises a balancing between parameter modifications selected to optimise the production the most efficiently, and parameter modifications designed to maintain an up to date memory of the more rarely used parameters. In this way, the method keeps a relatively recent memory of all parameter modifications allowing a faster adaptation to a previously unseen interplay between machine parameters and production quality.

Preferably, if a production output of the production machine is evaluated, this is done for a first time duration of at least 10 seconds, in order to counter noise and improve optimisation stability. More preferably, if the production machine outputs a number of discrete products, the first time duration may be chosen such that the number of discrete products output by the production machine is sufficiently large to allow for a statistically relevant analysis, e.g. at least 100 discrete products.

In an example of a production machine that comprises an oven for blow-stretching bottles, the heated air parameters may have effect nearly instantaneously, so it may suffice to wait just a few seconds, until bottles come in front of the sensor (e.g. 3 s). For example, if a measuring time of 12 s is taken, the overall time may be 12 s measure+3 s wait +12 s measure. For the oven, a wait time of 30 s may be set, counting about 20 s travel time through the line and 10 s for the oven to heat up or cool down to a new stable state.

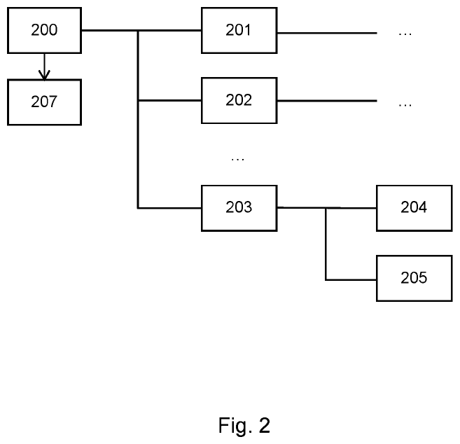

FIG. 2 schematically illustrates a production machine 200 having multiple parameters 201-203 for optimising using an aspect of a method according to the present disclosure, for example the same method 100 as in FIG. 1, in which case the production machine 200 would function as production machine 110 of FIG. 1.

The figure shows that production machine 200 leads to output 207, using a number of parameters of the production machine 200, of which three are shown: parameter 1, indicated with reference 201; parameter 2, indicated with reference 202; and parameter N, indicated with reference 203. Of course, the symbol N indicates that there may be any number of parameters of the production machine 200, which is indicated with an ellipsis sign between parameter 2 and parameter N.

For the sake of clarity, several features are shown only for parameter N, but analogous features may exist for the other parameters, for which analogous considerations apply. Parameter N is coupled with a predefined step size N, indicated with reference 204. The step size N may for example be a step size of minimal or convenient granularity for the parameter N. In a particular example, for example if parameter N represents oven temperature, the step size N may represent units of percentage, e.g. between 50% and 100%. All “ovens” (e.g. heating lamp arrangement) may for example be housed in the same box, making an individual oven temperature impossible to determine. Moreover, it has been found that oven lamps may be at their most efficient operation at around 80% power. Therefore, it may be preferred to set the minimum and/or maximum power of such lamps to values of 70% and/or 100% respectively, in order to stay close to the efficient range. When the optimisation starts, those values could be at 50%, for instance. As the optimisations continues, values may then for example only be moved towards the minimum and maximum boundaries. In an example, if a current lamp power value is 50%, 51% may be considered as a potential valid move, but not 49%, as 51% moves towards the range 70-100% from 50% whereas 49% does not. Over the course of the optimisation, the machine may thus move towards a more effective energy use. Of course, this insight may be extended to other types of parameters than lamp power (according the user manual of the machine), and of course the aim may extend beyond energy efficiency-it may for example be advantageous to limit any one or more of: component wear, noise, pollutant output, waste, etc.

In another particular example, the step size N may be 0.1 degree Celsius if that is the minimum step size allowed by the production machine 200, or it may be 0.5 or 1 degree Celsius if that is a convenient step size for the operator or for the optimisation by the aspect of a method according to the present disclosure.

In further developed aspects, the step size N may, over the course of the optimisation, be increased or decreased, if that is deemed useful for the optimisation. For example, early on during the optimisation, it may be advantageous to use a relatively larger step size, e.g. 5 degrees Celsius, as a convenient granularity, whereas later on during the 16 optimisation, it may be advantageous to use a relatively smaller step size, e.g. 0.5 degrees Celsius, as the convenient granularity.

Parameter N is also coupled with current value XN, indicated with reference 205, which represents the current value of parameter N as set in the production machine 200.

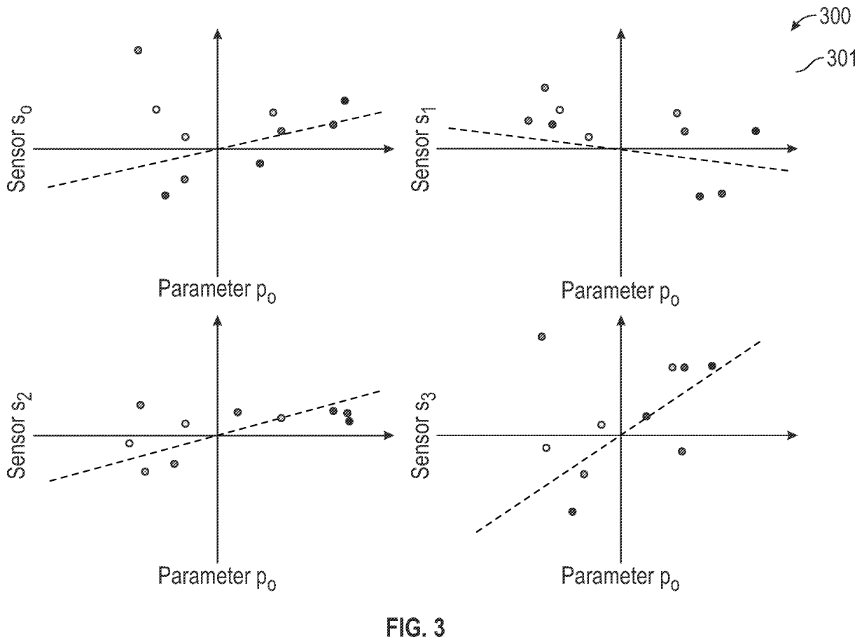

FIG. 3 schematically illustrates production variation in relation to variations of an arbitrary parameter p. The four panes represent the observed production variation (y-axis) according to sensors s₀, s1, s₂ and s₃ upon variation of parameter p₀ (x-axis). Such data points are used to fit the linear models (figured as dashed lines) underpinning parameter selection. Data points are plotted on a greyscale, representing the time dependent weights of the fit. Fitted models are used to predict production variation in response to production parameter modification; predictions from multiple models and a single parameter are further aggregated to predict the variation of the current cost function as defined by the machine operator.

Each data point is preferably taken into consideration in a regression, preferably a linear regression, wherein the age of the data point determines its weight (newer data points get higher weights) in a weighted combination of fitment curves or lines of the regression, and wherein each separate fitment curve or line of the regression for each data point also passes through the origin. As stated above, the number n of data points that is recorded (or at least taken into account when fitting the model and/or when selecting the second parameter) may preferably be limited to a value that is neither too small nor too large, e.g. a value of 10, so resulting in ten data points.

In other words, each model may be fitted with the latest 10 data points, with a linear decay of the weight of the data points in the fit. The latest data point (i.e. the most fresh, so the least stale data point) may for example have 10 times the weight of the earliest (i.e. the most stale) data point, and the 5th data point may for example have half that weight, so 5 times the weight of the earliest (i.e. most stale) data point, which is a form of decay, in the sense that the weights decrease for older data points. It is in principle possible to use the whole recorded database with every fit, for example by using an exponential decay across the entire recorded database (i.e. more stale data points are attributed an exponentially decreasing weight than more fresh data points).

The number n, i.e. the length of the queue, as well as the rate of the decay, are hyperparameters that may allow to tune the ratio of responsiveness to precision. If the system would generally behave similarly from one day to the another, it would be advantageous to use more data in order to have more precise results. If, on the other hand, the system would change more rapidly, it would be advantageous to use fewer data points, in order to retune more quickly to the new situation.

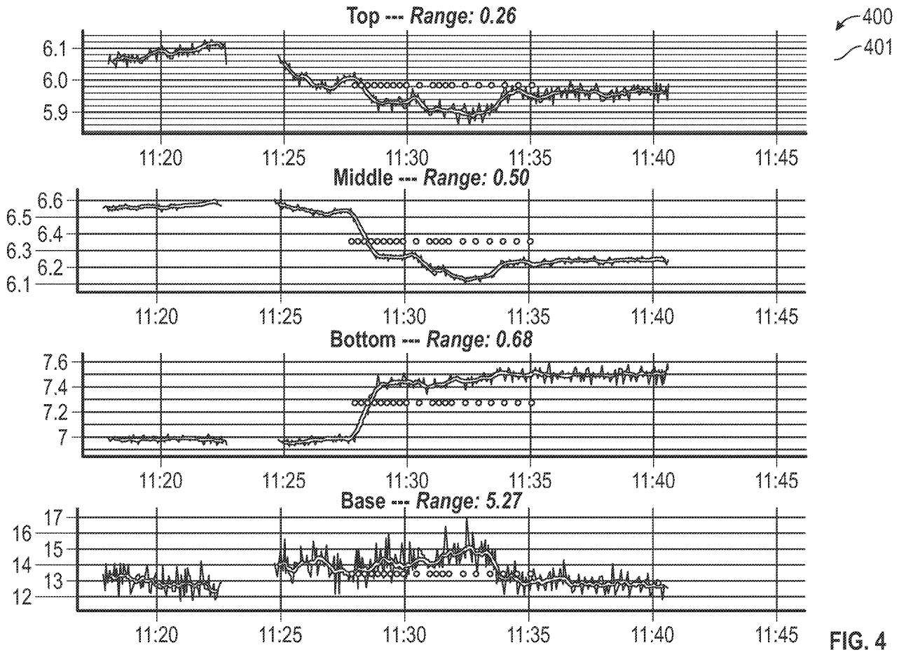

FIG. 4 is a snapshot of the data obtained over the course of an optimisation run. The four panels refer to four sensors recording a proxy value for bottle thickness at various heights (respectively the top, middle, bottom and base of the bottle), i.e. in different regions of the production machine. At around 11:27 that day, the optimisation started. In this scenario, the algorithm aimed at raising the plastic thickness at the bottom of the bottle from 7.0 to 7.4 (other locations were allowed “reasonable” thickness decreases). Each circle mark on the plots indicates that a parameter of the machine was modified and that the effect of the modification was recorded. From the start of the optimisation and within a few seconds, one can observe a significant redistribution of material thicknesses: bottom thickness jumps very close to its target, in all likelihood taking material from the upper parts of the bottle (as the top and middle sensors record a thickness decrease over the same period of time).

FIG. 4 schematically illustrates four graph panes of an output parameter, in this example material thickness, varying over time, due to modifications being made by operation of an aspect of a method according to the present disclosure, e.g. method 100.

1. A method for optimising a plurality of production parameters of a production machine having a production output, comprising, at a computer apparatus having access to a computer-readable storage medium and coupled to the production machine:
in a first step: modifying at least one first parameter of the plurality of production parameters, determining at least one corresponding impact on the production output due to said modifying, and storing the determined at least one corresponding impact on the production output on the computer-readable storage medium; and
in a second step: selecting a second parameter from among the at least one first parameter, based on the at least one stored corresponding impact on the production output for the at least one first parameter and based on a desired impact on the production output; and modifying the selected second parameter in order to optimise the production output towards the desired impact.

2. The method of claim 1, wherein the step of modifying the at least one first parameter in the first step comprises:
calculating at least one partial derivative of the at least one stored corresponding impact on the production output for the at least one first parameter;
wherein the second parameter is selected from among the at least one first parameter, based on the calculated at least one partial derivative.

3. The method of claim 1, comprising:
stabilizing the production machine by enforcing a stabilization time representing a time necessary for the corresponding impact to take effect on the production output due to said modifying of said respective first parameter, after said modifying of the at least one first parameter and/or the selected second parameter.

4. The method of claim 1, wherein the second step is repeated until a desired production output is achieved; and preferably wherein the first step and the second step are repeated in alternation until a desired production output is achieved.

5. The method of claim 1, comprising, when any parameter among the plurality of production parameters is modified by a modification in the first step and/or in the second step:
storing the modification of said parameter;
evaluating a corresponding change in the production output due to the modification, optionally after waiting for a settling time duration; and
storing the corresponding change.

6. The method of claim 5, wherein the corresponding change in the production output due to the modification is evaluated using a plurality of sensors, preferably arranged in different regions of the production machine, and wherein the step of selecting the second parameter from among the at least one first parameter based on the at least one stored corresponding impact on the production output for the at least one first parameter preferably comprises taking into account multiple objective functions corresponding with the plurality of sensors.

7. The method of claim 1, comprising, when any parameter among the plurality of production parameters is modified by a modification in the first step and/or in the second step, determining an impact on the production output of modifying said parameter, by:
retrieving at least one modification and at least one change in the production output corresponding with the at least one retrieved modification, for said parameter; and
fitting a regression model for the at least one retrieved modification and the at least one retrieved change for said parameter, in order to determine the impact on the production output of modifying said parameter.

8. The method of claim 1, wherein each parameter of the plurality of production parameters of the production machine is associated with a predetermined step size; and wherein the step of modifying the at least one first parameter in the first step comprises determining the modification for said parameter as either a decrease of at least one step size or an increase of at least one step size for said parameter, optionally subject to at least one pre-determined allowability criterion for modification of said parameter.

9. The method of claim 1, wherein the method further comprises:
determining, among the plurality of production parameters, at least one parameter lacking a respective determined impact; and
modifying the at least one parameter that has been determined to be lacking a respective determined impact, and determining at least one corresponding impact on the production output due to said modifying; and/or
wherein the method further comprises:
determining, among the at least one first parameter, at least one parameter having a most stale respective determined impact; and
modifying the at least one parameter that has been determined to be having a most stale respective determined impact and determining at least one corresponding impact on the production output due to said modifying.

10. The method of claim 1, wherein the step of selecting the second parameter further comprises:
sorting the at least one corresponding impact for the at least one first parameter according to a sorting criterion based on a respective contribution of the corresponding impact to the desired impact on the production output; and
choosing as the second parameter the parameter whose corresponding impact was sorted to have the highest contribution to the desired impact.

11. The method of claim 10, wherein the step of sorting the at least one respective impact for the at least one first parameter optionally takes into account respective parameter costs for respective parameters of the plurality of production parameters; and/or optionally takes into account respective modification costs for respective modifications to parameters of the plurality of production parameters.

12. A computer program comprising instructions configured for, when executed on a computer processor, performing the method of any previous claim.

13. A computer readable medium storing the computer program of claim 12.

14. A computer apparatus storing the computer program of claim 12 and configured for performing the method of claim 1.

15. A production machine (110, 200) operatively coupled to the computer apparatus of claim 14.
